(19) United States
(12) Patent Application Publication
(10) Pub. No.: US 2009/0009473 A1
(43) Pub. Date: Jan. 8, 2009

(54) Mouse with adjustable assembly

(76) Inventor: Shih-Hung Ho, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,450

(22) Filed: Jul. 6, 2007

(51) Int. Cl. G06F 3/033

(52) U.S. Cl. 345/163

(57) ABSTRACT

A mouse with an adjustable unit is disclosed. The mouse includes an upper casing and a lower casing, both of which form an accommodating space therebetween to receive a switch, a pressing unit, an adjustable unit, and a circuit board. The pressing unit further includes a plurality of keys formed on the upper casing. Each key has a protrusion on its lower surface. The adjustable unit further includes an adjustment member, a post mounted on one end of the adjustment member, and a plurality of resilient members located between the post and the protrusion.

### BACKGROUND OF THE PRESENT INVENTION

1. Field of the Present Invention

The present invention generally relates to a mouse with an adjustable unit. More particularly, the present invention relates to a mouse with an adjustable unit that allows users to adjust the required pressing force for operating a mouse according to the users' comfort or preferred feeling.

2. Description of the Related Art

Input devices are essential to computing devices. Among various input devices, the mouse is the most commonly used cursor operator, in addition to acting as an input means. For WINDOWS series software provided by MICROSOFT, OPERATION SYSTEM/OSX provided by APPLE company, computer-assisting graphic software such as AUTOCAD series software, or multimedia software, execution of the operations of a cursor and position clicking are performed almost exclusively via a mouse.

A conventional mouse includes a base, a circuit board, a set of keys, an upper casing, and a lower casing. The set of keys is operated by the means of point-to-point contact, using a resilient force offered by a resilient member such as a spring.

As shown in FIG. 1, a mouse 20 includes an upper casing 20A and a lower casing 20B. A plurality of keys 10 are formed on a front end of the mouse 20. A pressing rod 11 is mounted beneath each of the keys 10, and a resilient conductive sheet 22 is specially mounted under the pressing rod 11. When one of the keys 10 is pressed, the pressing rod 11 is driven to push the resilient conductive sheet 22 to contact a circuit board 50 so as to perform the operation of the mouse.

### SUMMARY OF THE PRESENT INVENTION

An object of the invention is to provide a mouse with an adjustable unit, in which the user can enjoy more and feel greater comfort when operating the mouse by adjusting the force needed to apply a pressing force against the keys.

In order to achieve the above and other objectives of the invention, the mouse includes an upper casing and a lower casing. The upper and the lower casings form an accommodating space therebetween to receive a switch, a pressing unit, an adjustable unit, and a circuit board.

According to one aspect of the invention, the pressing unit of the mouse is used to control the actuation of the switch, and includes a plurality of keys, a guiding stick, and a resilient conductive sheet.

According to another aspect of the invention, a key adjustment structure for a mouse including an upper casing and a lower casing is further provided. The key adjustment structure includes an adjustment hole formed in the lower casing, an adjustment member entering the accommodating space through the adjustment hole, a post formed on a front end of the adjustment member, and a resilient member sleeving the post and abutting against a lower surface of the key.

Without having to change the existing mouse structure, an adjustable unit can be added so that the user may enjoy multimedia with the improved pressing feeling of the mouse. In other words, the adjustable unit of the invention can be widely applied to various mice such as a three-key or two-key mouse, an optical mouse, a roller mouse, a wired or wireless mouse.

To provide a further understanding of the present invention, the following detailed description illustrates embodiments and examples of the present invention, this detailed description being provided only for illustration of the present invention.

### BRIEF DESCRIPTION OF THE DRAWINGS

FIG. 1 is a cross sectional view of a convention mouse.

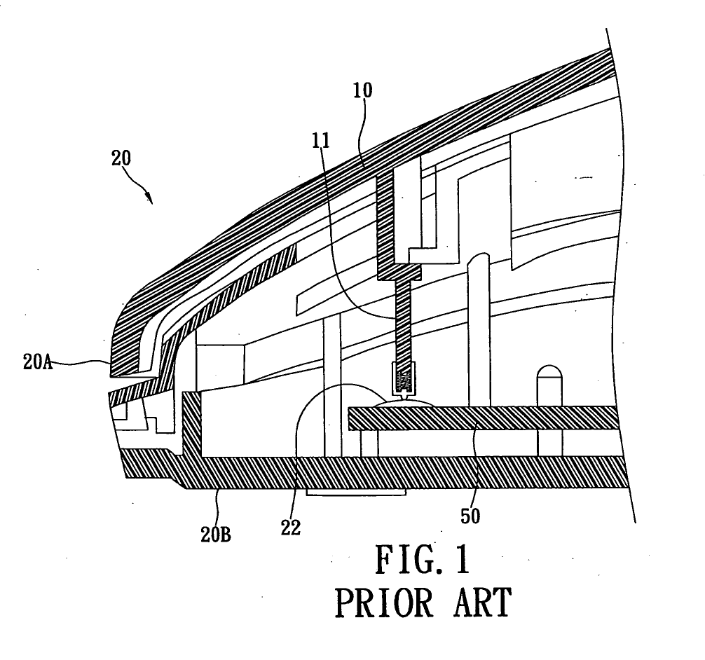

FIG. 2 is a cross-sectional view of a part of a mouse with an adjustable assembly according to one embodiment of the invention.

### DETAILED DESCRIPTION OF THE EMBODIMENTS

Wherever possible in the following description, like reference numerals will refer to like elements and parts unless otherwise illustrated.

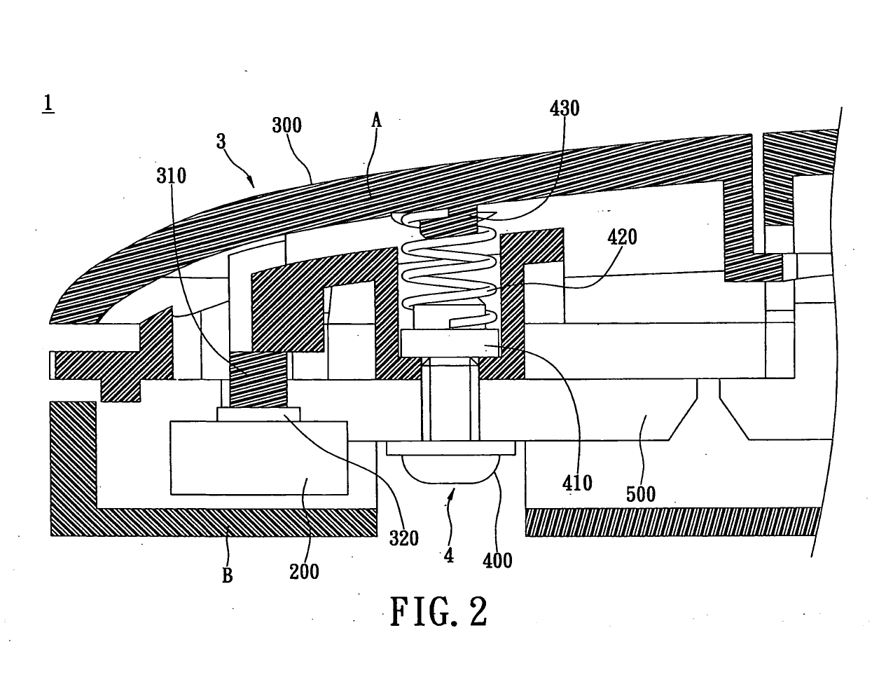

FIG. 2 is a cross-sectional view of a part of a mouse with an adjustment assembly according to one embodiment of the invention. As shown in FIG. 2, a mouse 1 includes an upper casing A and a lower casing B, both of which form an accommodating space to receive a switch, a pressing unit, an adjustable unit, and a circuit board.

The pressing unit 3 includes a plurality of keys 300, a guiding stick 310, and a resilient conductive sheet 320. The keys 300 are mounted on a front end of the mouse 1. Beneath each key 300 is mounted one guiding stick 310, a front end of which the resilient conductive sheet 320 is mounted in a manner that each key 300 is driven to bend slightly upward or downward. A switch 200 that is located under the resilient conductive sheet 320 can be actuated by connecting to or disconnecting from the conductive sheet 320. The resilient sheet 320 can be made of any electrically conductive material that can render the resilient sheet 320 to bend slightly upward and downward. During operation, when any of the keys 300 is pressed down, the guiding stick 310 is driven to press the switch 200 down to contact the circuit board 500, so as to perform a predetermined operation.

The adjustable unit 4 includes an adjustment member 400, a post 410, and a plurality of resilient members 420. The adjustment member 400 penetrates through a substrate 500 to abut against a lower surface of the corresponding key 300. One end of the adjustment member 400 is formed with the post 410. Each key 300 has a protrusion which allows the resilient member 420 to sleeve the protrusion 430 and the post 410. In one embodiment, the resilient member 420 is a spring.

The buffer stroke of the resilient member 420 can be adjusted by rotating the adjustment member 400 clockwise or counterclockwise to determine the force applied against the resilient conductive sheet 320 which is pressed down by the guiding stick. The feeling the user experiences when pressing the key can also be adjusted in the same way.

The part of the adjustment member 400 which contacts the circuit board 500 has a plurality of positioning levels by which the adjustment member 400 can stop at a predetermined level so that the force applied against the key 300 can be made constant. In detail, if the applied force is to be larger, the adjustment member 400 is rotated toward the lower casing B by shifting one level toward the accommodating space; thereby the buffer stroke of the resilient member 420 is made constant. The adjustment member 400 can be adjusted in the way recited above to reduce the buffer stroke of the resilient member 420 depending on the amount of force applied against the key 300. Similarly, the buffer stroke of the resilient member 420 can be increased by rotating the adjustment member 400 toward the accommodating space and stopping at one predetermined level, depending on the amount of the force that is applied against the key 300.

In order to prevent the adjustment member 400 from sliding from the predetermined level and mistakenly changing the pressing feeling of the key 300 due to the sliding of the adjustment member 400 during operation, a recess is further formed on a bottom of the mouse. The adjustment member 400 reaches the substrate through the recess.

The adjustment member 400 includes a threaded rod. The length of the adjustment member is not limited as long as the part of the adjustment member that is exposed through the substrate does not stretch out of the mouse. According to another aspect of the invention, a key adjustment structure for a mouse is provided. The mouse includes an upper casing and a lower casing. The upper and lower casings form an accommodating space. At least one key is mounted on the upper casing. The key adjustment structure includes an adjustment hole, an adjustment member, a post, and a resilient member.

The adjustment hole is formed through the lower casing, and has a plurality of positioning levels on its inner wall with certain pitches between levels. When the adjustment member is pushed toward the accommodating space of the mouse, the pressing force needed to press the key down is increased. Alternatively, when the adjustment member is pushed outward from the mouse, the force needed to press down on the key decreases. The pitch between the levels determines the change in the force needed to press the key down.

A post is formed at a front end of the adjustment member for the adjustment member and protrudes into the accommodating space through the adjustment hole.

The resilient member sleeves the post and abuts against a lower surface of the key. In one embodiment, the resilient member is a spiral resilient member such as a spring. The adjustment member is a threaded rod. The positioning levels can be in a spiral form.

In the present invention, without having to change the existing mouse structure, an adjustable unit can be added for the user to enjoy multimedia with the improved feeling of pressing the mouse. In other words, the adjustable unit of the invention can be widely applied to various mice such as a three-key or two-key mouse, an optical mouse, a roller mouse, a wired or wireless mouse.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A mouse with an adjustable unit, the mouse comprising an upper casing and a lower casing, the upper and the lower casings forming an accommodating space therebetween to receive a switch, a pressing unit, an adjustable unit, and a circuit board, wherein
the pressing unit further comprises
a plurality of keys, formed on the upper casing, wherein each key has a protrusion on its lower surface;
the adjustable unit further comprising
an adjustment member, penetrating through a substrate;
a post mounted on one end of the adjustment member; and
a plurality of resilient members, located between the post and the protrusion.

2. The mouse of claim 1, wherein the pressing unit comprises a plurality of keys, a guiding stick, and a resilient conductive sheet.

3. The mouse of claim 2, wherein the guiding stick is mounted beneath the respective key, the resilient conductive sheet is mounted on a front end of the guiding stick in a manner that the respective key is driven to bend slightly upward or downward to actuate or not to actuate the switch.

4. The mouse of claim 2, wherein the resilient conductive sheet is made of electrically conductive material.

5. The mouse of claim 1, wherein the part of the adjustment member which penetrates the substrate has a plurality of positioning levels.

6. The mouse of claim 5, wherein the positioning levels have a spiral form.

7. The mouse of claim 1, wherein the resilient member is a spring.

8. The mouse of claim, 1, wherein the adjustment member is an adjustment stick with threads.

9. A key adjustment structure for a mouse including an upper casing and a lower casing, the upper and lower casings forming an accommodating space therebetween, at least one key being mounted on the upper casing, the key adjustment structure comprising
an adjustment hole, formed in the lower casing, wherein the adjustment hole has positioning levels on its inner wall;
an adjustment member, entering the accommodating space through the adjustment hole;
a post, formed on a front end of the adjustment member; and
a resilient member, sleeving the post and abutting against a lower surface of the key.

10. The key adjustment structure of claim 9, wherein the part of the adjustment member which penetrates the substrate has a plurality of positioning levels.

11. The key adjustment structure of claim 10, wherein the positioning levels have a spiral form.

12. The key adjustment structure of claim 9, wherein the resilient member is a spring.

13. The key adjustment structure of claim 9, wherein the adjustment member is a threaded rod.
